(19) United States
(12) Patent Application Publication
(10) Pub. No.: US 2026/0174620 A1
(43) Pub. Date: Jun. 25, 2026

(54) SYSTEMS AND METHODS FOR RELEASING MUSCULAR TENSION

(71) Applicant: Michael PAGET, Glen Forrest (AU)

(72) Inventor: Michael PAGET, Glen Forrest (AU)

(21) Appl. No.: 19/542,481

(22) Filed: Feb. 17, 2026

Related U.S. Application Data
(63) Continuation of application No. 17/762,566.

(30) Foreign Application Priority Data
Sep. 25, 2019 (AU) 2019903593

(51) Int. Cl. A61H 15/00; A61H 15/02; B29K 75/00; C04B 26/16; C08L 75/04

(52) U.S. Cl. CPC A61H 15/0092; A61H 15/02; C04B 26/16; C08L 75/04; A61H 2015/005; A61H 2015/0071; A61H 2201/0107; A61H 2201/0207; B29K 2075/02

(57) ABSTRACT

Disclosed is a muscular tension releasing system that includes a therapy device. The therapy device includes a first end, a second end, and an elongate rod extending from the first end to the second end. The rod includes multiple treads including knobby bits; multiple receiving units to receive at least one tread; bearing surface(s) present on one of the first and second ends; and a coating of a durable material. The system also includes a strap including attachment unit(s) for attaching to at least one of the ends; and at least one holder for enabling a user to hold the strap for positioning the therapy device according to a body part where the user wants to put pressure on. The strap enables the user to control an amount of pressure exerted by the therapy device on one or more muscles of the body part.

### CROSS-REFERENCE TO RELATED APPLICATIONS

This application is a continuation of U.S. patent application Ser. No. 17/762,566, filed Sep. 22, 2020, which is a National Phase entry of International Application No. PCT/AU2020/050998 under § 371 and claims the benefit of Australian Patent Application No. 2019903593 filed on Sep. 25, 2019, each of which is hereby incorporated by reference in its entirety.

To the extent any amendments, characterizations, or other assertions previously made in any related patent applications or patents, including any parent, sibling, or child, with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

### TECHNICAL FIELD

The present disclosure is related to the field of muscle tension releasing devices. More particularly, the present disclosure relates to a muscular tension releasing system including a therapy device, and a strap for attaching to one or more ends of the therapy device. The strap enables a user to hold and position the therapy device on one or more muscles of a body part for controlling an extent of pressure applied on the one or more muscles.

### BACKGROUND

Any references to methods, apparatus or documents of the prior art are not to be taken as constituting any evidence or admission that they formed, or form part of the common general knowledge.

In today's fast and busy lifestyle, muscular pain has become so common with almost everyone. The middle-aged people and old aged people suffer from one or other type of muscular pain regularly. Muscular pain, such as Myofascial pain, is a chronic and very painful condition that affects a fascia that is a connective tissue that covers the muscles. Sometimes, the myofascial pain may involve more than one muscle. The fascia is a web like structure or a three-dimensional complex matrix of threads of muscles and filled with a clear gel like matter. The fascia is spread throughout the body of a user (like human), surrounding muscles, organs, nerves, bones, blood vessels and even the cells. Everything is held together and in place inside the body by fascia. The fascia is very flexible and infinitely adaptable. One or more knots may form in the fascia, which may be painful or may limit movement of an organ or muscle. Muscular pains may also be caused by inflammation of muscles or cell membranes. Doctors may prescribe some pain killers or medicines for relieving pain and reducing the internal inflammation. The medicines and pain killers may provide some relief but they have side effects.

Physiotherapy is another option for relieving muscular pain. The treatment of a muscular pain of a body part like neck, lower back, shoulder etc., usually require multiple sessions, hence a person may need to make multiple visits to a physiotherapy clinic. This in turn consumes lot of time and money.

Another option for relieving pain includes self-treatment by using an exercising/massaging device. Some non-limiting examples of the exercising/massaging devices that currently exists in the market may include a foam roller, a lacrosse ball, a theracane, a theragun, a peanut roller, a spikey ball, and a Battlestar device. All these exercising/massaging devices suffer from one or other limitations. For example, some are not easy to use or are heavy or are not compact. For using some exercising/massaging devices a user may require another person's help. Also, some of the exercising/massaging devices may not provide a long-term pain relief and are not very effective. Some of the devices may be effective but they are meant for a specific body part. For example, some devices, like spiker balls, are effective in releasing tension from the neck or shoulder, but such devices may not be suitable for use in leg pain. Therefore, the person may have to buy a different exercising/messaging device for different body parts, this in turn may increase the cost for self-treatment of the muscular pain.

In light of above, there exists a need for an improved muscular tension relieving device or systems. It is an object of the present invention to overcome or ameliorate the above discussed disadvantages of the prior art, or at least offer a useful alternative.

### SUMMARY

To address the above-mentioned issues, the present disclosure provides a compact and easy to use muscular tension releasing apparatus including a therapy device for releasing tension from one or more muscles of various body parts, and a strap for attaching to one or more ends of the therapy device. The strap may help a user to hold and position the therapy device in accordance with a body part where the user wants to use the therapy device. The muscular tension relieving apparatus is easy to use, modular, compact to carry everywhere, and can be used to relieve muscular tension of any body part such as, but not limited to, back, spine, shoulders, neck. legs, and so forth, of a user.

An object of the present disclosure is to provide a muscular tension releasing apparatus that is compact, easy to use, and can be used on any body part for relieving muscular tension and/or massaging.

The present disclosure also provides a myofascial release device (MFRD) or self-massage device enabling a user to alleviate muscle tightness and relieve tight fascia resulting in improved biomechanical function and an immediate feeling of relief.

An embodiment of the present disclosure provides a muscular tension releasing system including a therapy device including a first end, a second end, and an elongate rod extending from the first end to the second end. The elongate rod includes: a plurality of treads comprising a plurality of knobby bits; a plurality of receiving units configured to receive at least one tread of the plurality of treads; one or more bearing surface present on at least one of the first end and second end; and a coating of a durable material. The system also includes a strap including a plurality of interlocking units configured to connect to each other, the strap is configured to compress and expand; one or more attachment units for attaching to at least one of the first end and the second end of the therapy device; and at least one holder for enabling a user to hold the strap for positioning the therapy device according to a body part where the user wants to put pressure on. The strap enables the user to control an amount of pressure exerted by the therapy device on one or more muscles of the body part.

According to an aspect of the present disclosure, the rod is formed using a material comprising steel, iron, aluminum, wood, and carbon fiber.

According to an aspect of the present disclosure, a material of the plurality of treads comprises at least one of a silicon, rubber, plastic, wood, hard rubber, and polyurethane elastomer.

According to another aspect of the present disclosure, the plurality of treads are configured to be removed from the plurality of receiving units.

According to another aspect of the present disclosure, a shape of the plurality of treads comprises at least one of a hex design, a spiky design, and a twin design comprising a peanut shape for use on both sides of a spine at once.

According to another aspect of the present disclosure, the plurality of treads remain in a fixed position for enabling greater pressure and control.

According to another aspect of the present disclosure, the plurality of treads are configured to rotate for massaging the body part.

According to another aspect of the present disclosure, the therapy device further comprises an inbuilt vibration device configured to vibrate one or more treads of the plurality of treads.

According to another aspect of the present disclosure, the therapy device further comprises a heating device for heating at least one tread of the plurality of treads.

According to another aspect of the present disclosure, the system also includes a stand comprising one or more rollers configured to be slotted into the one or more bearing surface of the therapy device.

According to another aspect of the present disclosure, the strap comprises a plurality of interlocking units connected to each other, the strap is configured to compress and expand.

According to another aspect of the present disclosure, the strap is formed using a flexible and durable material comprising nylon, cloth, rubber, fabric, and plastic.

According to another aspect of the present disclosure, at least one end of the strap comprises an anchor for fixing to one of the first end and the second end of the therapy device.

Another embodiment of the present disclosure provides a myofascial release system for use on any body part of a user for muscular tension relief. The myofascial release system includes a therapy device comprising at least two ends comprising a first end and a second end, a rod extending from the first end to the second end, a plurality of treads present on a surface of the rod, and one or more bearing surface present on at least one of the first end and second end. The myofascial release system also includes a strap comprising one or more attachment units for attaching to at least one of the first end and the second end of t he therapy device, the strap further comprises one or more holder for enabling a user to hold the strap for positioning the therapy device on a body part where the user wants to put pressure on. The strap may enable the user to control an amount of pressure exerted by the therapy device on one or more muscles of the body part. Further, the strap enables the user to use therapy device for releasing tension from one or more muscles by exerting pressure on the muscles with less effort.

Yet another embodiment of the present disclosure provides a method for releasing muscular tension from a body part of a user. The method includes providing a therapy device comprising a first end and a second end, a rod extending from the first end to the second end, a plurality of treads present on a surface of the rod, and one or more bearing surface present on at least one of the first end and second end. The method also includes attaching a strap to the therapy device, wherein the strap comprises one or more attachment units for attaching to at least one of the first end and the second end of the therapy device, the strap further comprises one or more holder for enabling a user to hold the strap for positioning the therapy device on a body part where the user wants to put pressure on. Further, the strap enables the user to control an amount of pressure exerted by the therapy device on one or more muscles of the body part. The method also includes holding the strap for leveraging and controlling a pressure exerted by the therapy device on the body part.

Another embodiment of the present disclosure provides a muscular tension releasing system for releasing one or more knots of muscles of a body part of a user. The muscular tension releasing system includes a modular therapy device formed by assembling a plurality of pieces together. The modular therapy device includes a first end and a second end, a rod extending from the first end to the second end, a plurality of receiving units configured to receive a plurality of removable treads, one or more bearing surface present on the first end and second end, a heating device for heating one or more treads of the plurality of treads, and an inbuilt vibration device for vibrating the one or more treads of the plurality of treads. The muscular tension releasing system also includes a strap including a plurality of interlocking units configured to connect to each other to form a chain like structure configured to compress and expand. The strap includes one or more attachment units for attaching to at least one of the first end and the second end of the therapy device. The strap also includes at least one holder for enabling a user to hold the strap for positioning the therapy device according to a body part where the user wants to put pressure on. The strap enables the user to control an amount of pressure exerted by the therapy device on one or more muscles of the body part. The system also includes a stand including one or more rollers configured to be slotted into the one or more bearing surface of the modular therapy device.

According to another aspect of the present disclosure, a shape of the plurality of treads comprises at least one of a hex design, a spiky design, and a twin design comprising a peanut shape for use on both sides of a spine at once. Further, the plurality of removable treads are configured to be removed from the plurality of receiving units of the therapy device. Furthermore, a material of the plurality of treads comprises at least one of a silicon, rubber, plastic, wood, hard rubber, and polyurethane elastomer.

According to another aspect of the present disclosure, the strap is formed using a flexible and durable material comprising nylon, cloth, and plastic. Further, at least one end of the strap comprises an anchor for fixing to one of the first end and the second end of the therapy device.

Another embodiment of the present disclosure also provides a therapy device for releasing muscular tension, comprising: a first end; a second end; and an elongate rod extending from the first end to the second end. The elongate rod comprises: a plurality of treads comprising a plurality of knobby bits; a plurality of receiving units configured to receive at least one tread of the plurality of treads; one or more bearing surface present on at least one of the first end and second end; and a coating of a durable material.

### BRIEF DESCRIPTION OF THE DRAWINGS

Preferred features, embodiments and variations of the invention may be discerned from the following description which provides sufficient information for those skilled in the art to perform the invention. The description is not to be regarded as limiting the scope of the preceding summary of the invention in any way.

Specific embodiments of the present invention are described, by way of example only, with reference to the accompanying drawings, in which:

FIG. 1A illustrates an exemplary muscular tension releasing system 100A, in accordance with an embodiment of the present disclosure;

FIG. 1B illustrates another exemplary muscular tension releasing system 100B, in accordance with another embodiment of the present disclosure;

FIG. 2 illustrates an exemplary therapy device 200, in accordance with another embodiment of the present disclosure;

FIG. 3 illustrates another exemplary therapy device 300, in accordance with another embodiment of the present disclosure;

FIG. 4 illustrates a modular therapy device 400 in disassembled configuration, in accordance with another embodiment of the present disclosure; and

FIG. 5A illustrates an exemplary muscular tension releasing system including a therapy device, in accordance with another embodiment of the present disclosure;

FIG. 5B illustrates exemplary size and dimensions possible for the exemplary therapy device of the muscular tension releasing system; and

FIG. 5C illustrates the exemplary therapy device of the muscular tension releasing system in disassembled configuration.

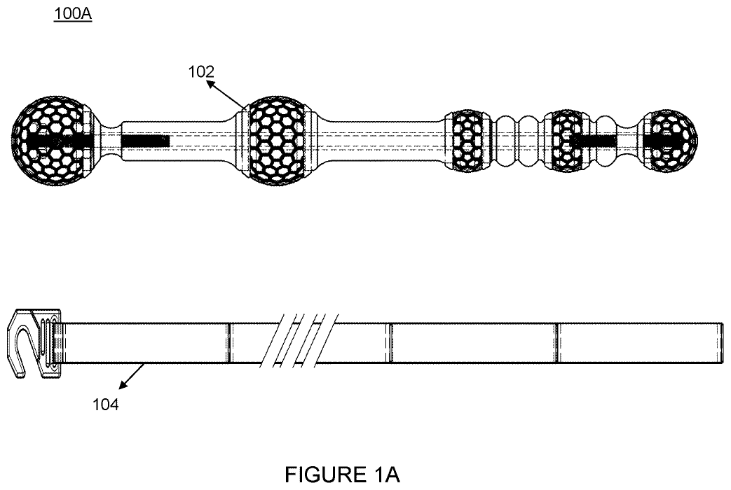

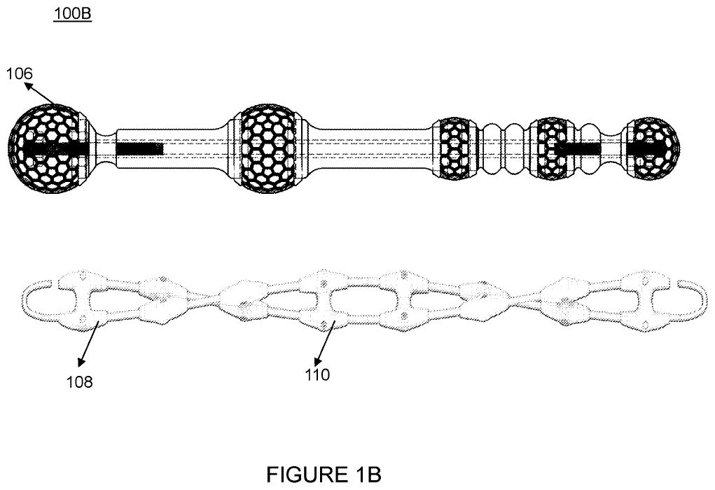

Referring to FIG. 1A, the exemplary muscular tension releasing system 100A includes a therapy device 102 and a strap 104. The muscular tension releasing system 100A may be used to ease tension in muscles and relieve fascia that is knotted up. The fascia may be a web like structure formed of threads of muscles and filled with a clear gel like matter. The fascia is a three-dimensional complex matrix that may threads itself throughout the body of a user (like human), surrounding muscles, organs, nerves, bones, blood vessels and even the cells. Everything is held together and in place by the fascia. The fascia is impressively flexible and infinitely adaptable. One or more knots may form in the fascia, which may be painful or may limit movement of an organ or muscle.

The therapy device 102 includes a first end and a second end, a rod extending from the first end to the second end, a plurality of treads present on a surface of the rod, and one or more bearing surface present on at least one of the first end and second end. The rod of the therapy device 102 may be formed using a suitable material such as, but not limited to, steel, iron, aluminum, wood, and carbon fiber. In some embodiments, a material of the plurality of treads includes such as, but not limited to, at least one of a silicon, rubber, plastic, wood, hard rubber, and polyurethane elastomer. In some embodiments, the plurality of treads may be removable treads and may have varying shore hardness. Further, the treads may have different size, shape, and shore hardness. The shore hardness may be a measure of a resistance a material has to indentation. The therapy device 102 can be customized according to user's preferences, for example, the user may remove one or more treads and can use the therapy device 102 with or without the strap 104. In some embodiments, the shape of the treads may be at least one of hex design, spikey design, twin design like in a shape of a peanut shape for use on both sides on the spine at once, and so forth. In some embodiments, the plurality of treads remains in a fixed position for enabling greater pressure and control. In alternative embodiments, the treads are configured to rotate for massaging the body part. In other embodiments, one or more treads of the plurality of treads move and/or rotate and other treads of the plurality of treads remain fixed.

In some embodiments, the bearing surfaces, where an attachment unit such as a hook of a strap goes may spin and may have needle bearings beneath them. Further, in some embodiments, the system 100A may include a stand (may also be referred as a Jack) which may turn the system 100A into a stationary roller.

Further, the receiving units of the system 100A may be in shape of a peanut. Further, the system 100A may include at least one of a peanut head, a cylindrical head, a spiky head, and so forth. In some embodiments, the system 100A may include a small chrome ball on the one of the ends of the system 100A for jaw work.

In some embodiments, the strap 104 may include one or more attachment units for attaching to at least one of the first end and the second end of the therapy device 102. The attachment units may be in shape of an anchor, hooks, loop, clips, and so forth. The strap 104 further includes one or more holder for enabling a user to hold the strap 104 for positioning the therapy device 102 on a body part where the user wants to put pressure on. Further, the strap 104 enables the user to control an amount of pressure exerted by the therapy device 102 on one or more muscles of the body part. In some embodiments, at least one end of the strap 104 includes an anchor for fixing to one of the first end and the second end of the therapy device 102. Further in some embodiments, the strap 104 includes adjusting means for adjusting a length of the strap 104.

The therapy device 102 may be made of a rod, one or more receiving units, and a plurality of treads. The receiving units are configured to receive at least one of the plurality of treads. In some embodiments, the rod includes a coating of suitable material such as, but not limited to, hard plastic, polyurethane elastomer, wood, rubber, and so forth. In some embodiments, the therapy device 102 includes an inbuilt vibration device configured to vibrate one or more treads of the plurality of treads. In some embodiments, the therapy device 102 includes a heating device for heating one or more treads of the plurality of treads.

The strap 104 may be used as an anchor for attaching to the therapy device so that the user can put pressure on muscles or knotted fascia. In some embodiments, the strap 104 may be made of nylon webbing and may include hook that may clip or attach to aluminum bearing surfaces on each end of the therapy device. In an example, the strap is 1900 mm long. The strap 104 enables a user to leverage without contorting against a wall and result in a lot of pressure at one or more muscles with little effort. The strap 104 may allow the user to use the therapy device 102 in a convenient manner for treating one or more or all points on the body of the user with little effort and with great control.

Further, the therapy device 102 may be used with or without the strap 104. For example, the therapy device 102 may be used on the floor or against the wall for treating one or more or all points on the body of the user with little effort and with great control.

Further, the muscular tension releasing system 100A can be used on any muscle or body part of the user such as, but not limited to, neck, shoulders, biceps, forearms, legs, thighs, lower back, lateral deltoid muscle, and so forth. In some embodiments, the user may use the muscular tension releasing system 100A as a self-massage device to alleviate muscle tightness and relieve tight fascia resulting in improved biomechanical function and an immediate feeling of relief.

FIG. 1B illustrates another exemplary muscular tension releasing system 100B includes a therapy device 106 and a strap 108 formed using a plurality of interlocking units 110. The therapy device 106 is similar to the therapy device 102 and includes a first end and a second end, a rod extending from the first end to the second end, a plurality of treads present on a surface of the rod, and one or more bearing surface present on at least one of the first end and second end. In some embodiments, the rod includes a coating. The rod may include a coating of suitable material such as, but not limited to, polyurethane elastomer (hard plastic). In some embodiments, the therapy device 106 includes a heating device for heating one or more treads of the plurality of treads, and/or an inbuilt vibration device for vibrating the one or more treads of the plurality of treads.

In some embodiments, the treads may remain in a fixed position for enabling greater pressure and control. In alternative embodiments, the treads are configured to rotate for massaging the body part. The treads are configured to be removed from the therapy device. A material of the plurality of treads may include, but is not limited to, silicon, rubber, plastic, wood, hard rubber, and polyurethane elastomer.

As shown, the strap 108 includes the plurality of interlocking units 110 configured to connect to each other. The strap 108 is configured to compress and expand. Further, the strap 108 may include one or more attachment units for attaching to at least one of the first end and the second end of the therapy device 106. Examples of the attachment units may include, but are not limited to, hooks, anchor, clips, threads, and so forth. The strap 108 further includes one or more holder for enabling a user to hold the strap 108 for positioning the therapy device 106 on a body part where the user wants to put pressure on. Further, the strap 108 enables the user to control an amount of pressure exerted by the therapy device 106 on one or more muscles of the body part. In some embodiments, at least one end of the strap 108 includes an anchor for fixing to one of the first end and the second end of the therapy device 106. The strap 114 may be formed using a flexible and durable material comprising nylon, cloth, plastic, rubber, and so forth.

In some embodiments, one or more interlocking units of the plurality of interlocking units 110 of the strap 108 may be removed or added for adjusting a length of the strap 108. In a non-limiting example, the length of the strap 108 is 1900 mm. The strap 108 is configured to compress and expand.

In some embodiments, the therapy device 106 may be made of a 14-millimeter (mm) steel rod coated in polyurethane elastomer (hard rubber) and may have at least five treads of silicon. The interlocking units 110 may be made up of rope, threads, nylon, rubber, fiber, cloth, plastic, and so forth. The strap 108 may be formed using a flexible and durable material comprising nylon, cloth, rubber, fabric, and plastic. In some embodiments, at least one end of the strap 108 may include an anchor for fixing to one of the first end and the second end of the therapy device. In some embodiments, the therapy device 106 includes a heating device for heating one or more treads of the plurality of treads, and an inbuilt vibration device for vibrating the one or more treads of the plurality of treads.

The muscular tension releasing system 100A, and 100B (hereinafter collectively may be referred as muscular tension releasing system 100) may be a myofascial release device (MFRD) or a self-massage device for enabling a user to alleviate muscle tightness and relieve tight fascia resulting in improved biomedical function and an immediate feeling of relief. Further, the muscular tension releasing system 100 may be used on any body part or muscles of the user's body such as, but not limited to, biceps, shoulders, lower back, lateral deltoid (i.e. an outside muscle next to a posterior deltoid muscle). The muscular tension releasing system 100 can do all the muscles of the body of the user.

In some embodiments, the muscular tension releasing system 100A, and 100B may include a stand including one or more rollers configured to be slotted into the one or more bearing surface of the therapy device.

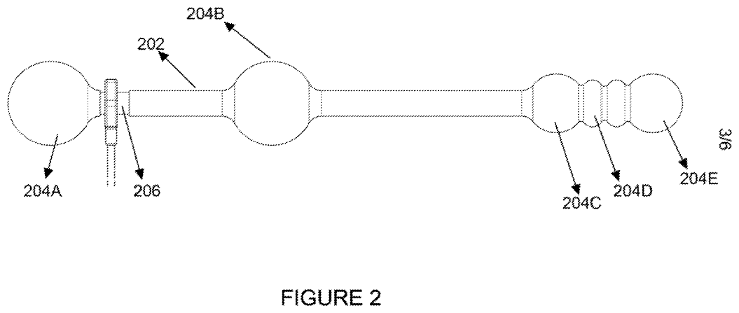

FIG. 2 illustrates the exemplary therapy device 200, in accordance with another embodiment of the present disclosure. As shown the therapy device 200 includes a first end and a second end, a rod 202 extending from the first end to the second end, a plurality of knob heads such as five knob heads 204A-204E formed at one or more location on an external surface of the rod 202, and one or more bearing surface 206 present on at least one of the first end and second end. The rod 202 of the therapy device 200 is formed using a material such as, but not limited to, steel, iron, aluminum, wood, and carbon fiber.

In some embodiments, the plurality of knob heads 204A-204E may have a suitable shape such as, but not limited to, spherical, oval, cubical, and so forth.

In some embodiments, the therapy device 200 includes a heating device for heating one or more knob heads of the plurality of knob heads 204A-204E. Further, in some embodiments, the therapy device 200 may include an inbuilt vibration device for vibrating the one or more knob heads of the plurality of knob heads 204A-204E. Further in some embodiments, the knob heads 204A-204E remain in a fixed position for enabling greater pressure and control. In alternative embodiments, the knob heads 204A-204E are configured to rotate for massaging the body part.

In an example, the therapy device 200 includes a 14 mm long steel rod coated in polyurethane elastomer (hard plastic) and has at least five knob heads 204A-204E. The knob heads 204A-204E may be formed using silicon and may have varying shore hardness. A strap may include at least one attachment unit such as one or more hooks for clipping onto the one or more bearing surface 206 on each of the first end and the second end of the therapy device 200. The one or more bearing surface 206 may be made up of aluminum.

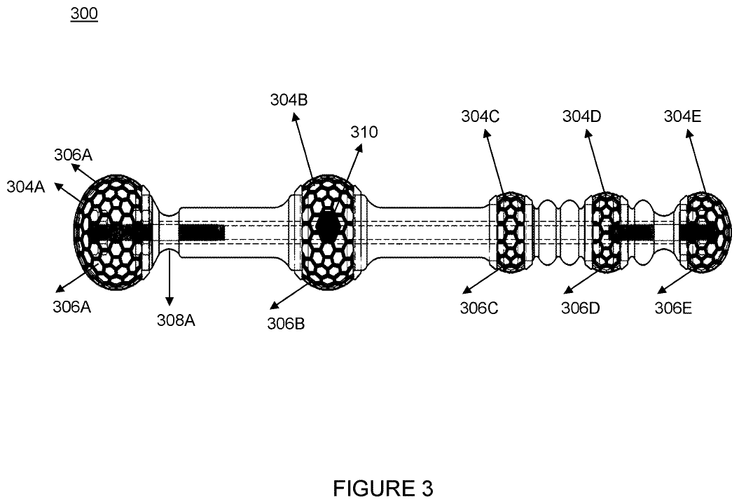

Turning now to FIG. 3, another exemplary therapy device 300 is illustrated, in accordance with another embodiment of the present disclosure. As shown the therapy device 300 includes at least two ends including a first end and a second end, a rod 302 extending from the first end to the second end, a plurality of treads such as, five treads 306A-306E, present on a surface of the rod 302, and one or more bearing surface, such as two bearing surfaces 308A-308B, present on at least one of the first end and second end. The bearing surfaces 308A-308B may be formed using a suitable material such as, but not limited to, aluminum, steel, copper, wood, and carbon fiber. The rod 302 further includes a coating of a durable material. Further, a shape of the plurality of treads 306A-306E may be a twin design comprising a peanut shaped tread(s) for use on both sides of a spine at once.

In some embodiments, the rod 302 is an elongate rod 302 extending from the first end to the second end. The elongate rod 302 includes a coating of a durable material such as, but not limited to, polyurethane elastomer. The elongate rod 302 further includes the plurality of treads 306A-306E. The rod 302 further includes a plurality of receiving units, such as five receiving units 304A-304E, configured to receive at least one tread of the plurality of treads 306A-306E. Each of the plurality of treads 306A-306E includes a plurality of knobby bits. The rod 302 further includes one or more bearing surface, such as the two bearing surfaces 308A-308B, present on at least one of the first end and second end.

In some embodiments, the receiving units 304A-304E may vary in shape, for example, the shape may be spherical, cylindrical, peanut-shaped oval, cubical, and so forth. In some embodiments, all the receiving units 304A-304E may be of same size and shape. In alternative embodiments, one or more of the receiving units 304A-304E may be of different size and shape. Further, the shape, and size of the receiving units 304A-304E is according to a shape and size of the plurality of treads 306A-306E. As shown, the receiving units 304A-304E are spherical in shape in the therapy device 300. In some embodiments, a receiving unit present towards at least one of the first and second ends may be referred as a head. For example, the receiving unit 304A may be referred as a head. The head may be peanut shaped in some embodiments.

The knobby bits of the plurality of treads 306A-306E are designed in such a way so when a user put a hook (or attachment unit of the strap of the muscular tension releasing system) on a bearing surface near a big end, for example the bearing surface 308A near the first end, then a tread with a hex design 310 sits right in the meat of the top of user's your trapezius muscle.

The rod 302 and/or the receiving units 304A-304E may be formed using a suitable material comprising such as, but not limited to, steel, iron, aluminum, wood, and carbon fiber. In some embodiments, the receiving units 304A-304E are configured to be detached from the rod 302. In alternative embodiments, the receiving units 304A-304E may form a unitary structure with the rod 302 and may not be detached from the rod 302.

Further, a material used for making the plurality of treads 306A-306E may include such as, but not limited to, silicon, rubber, plastic, wood, hard rubber, and polyurethane elastomer. In some embodiments, the plurality of treads 306A-306E are removable treads. In other embodiments, the treads 306A-306E configured not to be removed from the receiving units 304A-304E. Further, a shape of the treads 306A-306E and/or the knobby bits on the treads 306A-306E may include such as, but not limited to, a hex design, a spiky design, and a twin design comprising a peanut shape for use on both sides of a spine at once. In some embodiments, the treads 306A-306E are fixed and remain in a fixed position for enabling greater pressure and control. In alternate embodiments, the plurality of treads 306A-306E are configured to rotate for massaging the body part.

In some embodiments, the therapy device 300 may include an inbuilt vibration device configured to vibrate one or more treads of the plurality of treads 306A-306E. Further, the therapy device 300 may include a heating device for heating at least one tread of the plurality of treads 306A-306E.

In some embodiments, a stand comprising one or more rollers can be slotted into the one or more bearing surface like the surface 308A of the therapy device 300. In some embodiments, an anchor of the strap can fix to one of the first end and the second end of the therapy device 300.

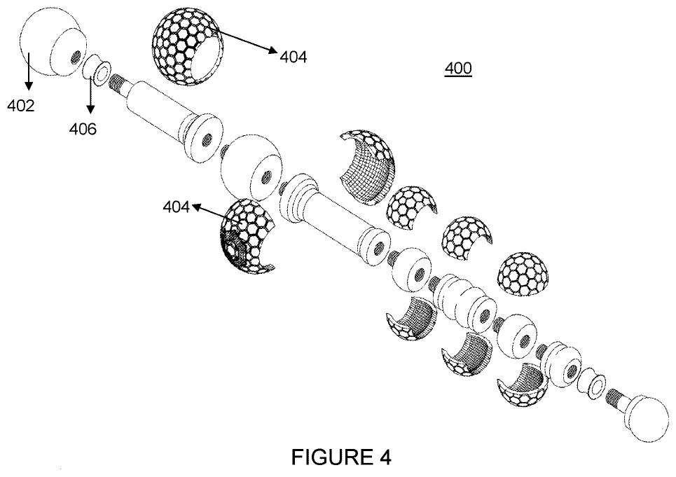

Referring to FIG. 4, the modular therapy device 400 in disassembled configuration is illustrated, in accordance with an embodiment of the present disclosure. The modular therapy device 400 includes multiple pieces as shown. In an embodiment, the modular therapy device 400 includes eleven pieces. All the pieces may be assembled together to form the modular therapy device 400. Though not shown, but a person skilled in the art will understand that the modular therapy device 400 may include more or less than eleven pieces.

The modular therapy device 400 once assembled may include a first end and a second end as shown in FIG. 4. The modular therapy device 400 also includes a rod extending from the first end to the second end, a plurality of receiving units 402 configured to receive at least one of a plurality of removable treads 404, and one or more bearing surface 406, e.g. bearing 1 and bearing 2, present on the first end and the second end. The removable treads 04 may also be referred as treads 404 without change in its meaning.

In some embodiments, the modular therapy device 400 may include a heating device for heating one or more treads of the plurality of removable treads 404. In further embodiments, the modular therapy device 400 includes an inbuilt vibration device for vibrating the one or more treads of the plurality of treads 404.

In some embodiments, the one or more treads or the plurality of treads 404 remain in a fixed position for enabling greater pressure and control on one or more muscles of a body part that is in contact with the one or more treads. In alternative embodiments, the one or more treads or the plurality of treads 404 are configured to rotate for massaging the body part. In some embodiments, the one or more treads or the plurality of treads 404 may vibrate.

Further, a shape of the plurality of treads 404 may include at least one of a hex design, a spiky design, and a twin design such as in shape of a peanut shape for use on both sides of a spine at once. In some embodiments, the plurality of removable treads 04 are configured to be removed from the plurality of receiving units 402 of the modular therapy device 400. In some embodiments, non-limiting examples of a material of the plurality of treads 404 may include at least one of a silicon, rubber, plastic, wood, hard rubber, and polyurethane elastomer.

The modular therapy device 400 may be used on any body part with or without a strap. The strap may be similar to the strap 104 of FIG. 1A. The strap 104 may include one or more attachment units such as, a hook for attaching to at least one of the first end and the second end of the modular therapy device 400. The strap 104 further includes one or more holder for enabling a user to hold the strap 104 for positioning the modular therapy device 400 on a body part where a user wants to put pressure on. Further, the strap 104 enables the user to control an amount of pressure exerted by the modular therapy device 400 on one or more muscles of the body part. In some embodiments, at least one end of the strap 104 includes an anchor for fixing to one of the first end and the second end of the modular therapy device 400.

The modular therapy device 400 is easy to assemble and disassemble. Once disassembled, the modular therapy device 400 becomes compact that may be easy to carry. Further, the modular therapy device 400 may be formed using lighter and durable material such as, but not limited to, carbon fiber, aluminum, and so forth.

In some embodiments, the bearing surfaces 406, where the attachment unit such as the hook of the strap goes may spin and/or may have needle bearings beneath them. Further, in some embodiments, the system 400 may include a stand (may also be referred as a Jack) which may turn the system 400 into a stationary roller.

Further, the one or more of the receiving units 404 of the system 400 may be in shape of a peanut. Further, the system 400 may include at least one of a peanut head, a cylindrical head, a spiky head, and so forth. In some embodiments, the system 400 may include a small chrome ball on the one of the ends of the system 400 for jaw work.

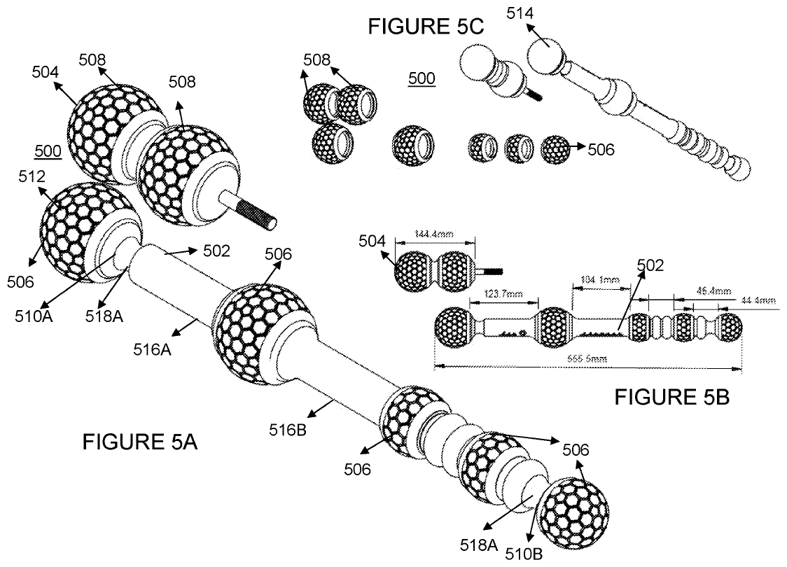

FIG. 5A illustrates an exemplary muscular tension releasing system 500, in accordance with another embodiment of the present disclosure. The system 500 includes a modular therapy device 502 and an attachment accessory 504 for the therapy device 502. The therapy device 502 may include a rod extending from a first end 510A to a second end 510B. The attachment accessory 504 can replace at least one or both or the ends 510A-510B of the therapy device 502. The rod includes a plurality of treads 506 including a plurality of knobby bits 512. Further, the rod includes a plurality of receiving units 514 configured to receive at least one tread of the plurality of treads 506. In some embodiments, the treads 506 may have spikes. In some embodiments, the receiving units 514 present towards the first end and the second end may be referred as heads. Further, at least one of the heads may be in any suitable shape such as, but not limited to, spherical, peanut, and cylindrical. The rod also includes one or more bearing surface present on at least one of the first end 510A and second end 510B.

One or both of the heads (i.e. spheres at each of the ends 510A-510B) can be removed and the attachment accessory 504 can be attached to that specific end of the ends 510A-510B. As shown, the attachment accessory 504 is configured to be attached to a bearing or nexus part 518A or 518B of the rod. The rod includes a shank 516 including a top shank 516A and a center shank 516B. The end spheres can be screwed into the main shank 516—enabling the replacement and/or assembly of the nexus parts 518A-518B. The nexus parts 518A-518B are the positions for attachment to the hook/anchor of the strap and may have bearings underneath so they spin freely in the preferred embodiment. Without the nexus parts 518A-518B, the therapy device 502 may be made as a single piece in some embodiments. The nexus parts 518A-518B may greatly enhance the experience and would need to be slid onto the central steel shaft upon assembly. In some embodiments, when wood is used to make the therapy device, then the therapy device will not have bearing surfaces that spin freely.

The attachment accessory 504 can be screw into either of the ends 510A-510B. Further, in some embodiments, the attachment accessory 504 may be in shape of a peanut as shown. The peanut shaped accessory attachment 504 may be used on the muscles going up either side of the spine of the user.

In some embodiments, the attachment accessory 504 may include roller(s) to offer more stability on smaller muscles such as, the Terres Minor. The rollers type attachment accessory may be of slightly longer dimension to the spheres—for example, but not limited to, 1.5 times the size of the spheres. In some embodiments, the accessory attachment 504 may be shaped like a cylinder—or roller.

Further, in alternative embodiments, the accessory attachment 504 may be a spikey ball. The purpose of the spikey ball type attachment accessory 504 may be to dig into the fibers of the muscles and fascia. The spikey ball may be some user's preferred coating for myofascial devices.

In some embodiments, the attachment accessory 504 may include smooth metallic sphere in three sizes, large, medium, and small (about 20 mm in diameter) The smooth metallic sphere type of the attachment accessory 504 is designed to slide over the surface of the skin of the user. The smooth metallic sphere type of the attachment accessory 504 might be of preference to professionals using the device 502 on their clients with massage oil—such as massage therapists and exercise physiologists etc. The smaller sizes would be great for the jaw area and temple etc.

Further, the attachment accessory 504 may include a twin design or a double head that may be in any suitable shape such as, but not limited to, spherical, peanut, and cylindrical. Further, the attachment accessory 504 may have a spiky head in some embodiments. Each of the modular therapy device 502 and the attachment accessory 504 includes a plurality of treads 506 and 508 that may further include a plurality of knobby bits.

FIG. 5B illustrates exemplary size and dimensions possible for the exemplary muscular tension releasing system 500 and various individual parts of the therapy device 502. In some embodiments, the treads 506 and 508 may have spikes. Further, the length of the device 502 may vary. In some embodiments, the therapy device 502 may include a heating device for heating one or more treads of the plurality of treads 506. Further, in some embodiments, the therapy device 502 may include an inbuilt vibration device for vibrating the one or more treads of the plurality of treads 506.

FIG. 5C illustrates the exemplary therapy device 502 of the muscular tension releasing system 500 in disassembled configuration. The plurality of treads 506 and 508 comprising the plurality of knobby bits can be removed from the modular therapy device 502 and the attachment accessory 504, respectively as shown in FIG. 5C.

The system 500 may also include a strap including one or more attachment unit(s) for attaching to at least one of the first and second ends; and at least one holder for enabling a user to hold the strap for positioning the therapy device 502 according to a body part where the user wants to put pressure on. The strap may also enable the user to control an amount of pressure exerted by the therapy device 502 on one or more muscles of the body part. The shape, length, and size of the strap may vary.

The present disclosure provides a myofascial release device configured to be used to ease tension in muscles and relieve fascia that is knotted up. The myofascial release device includes a therapy device having a first end and a second end, and a strap. The strap may be formed using a suitable material such as, but not limited to, nylon. In an example, the strap includes a nylon webbing. The strap includes one or more hooks for attaching to or clipping onto a bearing surface on each of the first end and the second end. The strap may be used as an anchor to allow the user to put pressure on a body part or a knotted fascia.

According to an aspect of the present disclosure, the therapy device includes at least five treads made up of a suitable material such as, but not limited to, silicon. The plurality of treads are removable treads.

In some embodiments of the present disclosure, the rod of the therapy device is a 14-millimeter steel rod encased in a polyurethane elastomer or hard rubber. The rod further includes a plurality of removable silicon treads.

In alternative embodiments of the present disclosure, the rod of the therapy device is made of aluminum. The treads of the therapy device are removable and may be formed using a suitable material such as, but not limited to, rubber, or silicon.

In alternative embodiments of the present disclosure, the rod of the therapy device is formed using a lightweight material like, but not limited to, carbon fiber. The rod may include multiple modules that are configured to assembled together for making a rod. The multiple modules may be unscrewed or may be break down in the middle of the rod so that it can be easily carried from one location to other.

In some embodiments of the present disclosure, the plurality of treads have varying shore hardness. In some embodiments of the present disclosure, a material used for making the plurality of treads may include but are not limited to, silicon, and rubber.

In some embodiments of the present disclosure, the muscular tension releasing system can be used to release tension from all the muscles in a body of the user. The muscular tension releasing system can be used with the strap or without the strap. For example, the therapy device alone may be used on the floor or against the wall to massage one or more muscles (or muscles' points) on the body. This way multiple muscles can be massages or treated with little effort and with great control.

According to an aspect of the present disclosure, the strap includes one or more holder for enabling the user to hold the strap via hand or foot. In some embodiments of the present disclosure, the one or more holder (or units) are sewn at 200 mm intervals.

The disclosed muscular tension releasing system may include a therapy device which is a modular device formed using multiple pieces. For example, in some embodiments, the therapy device is formed using eleven pieces and five treads.

In some embodiments of the present disclosure, the strap is made of a flexible material and an ultra-durable material for usage in outdoors such as, but not limited to, nylon, cloth, and plastic. The length and width of the strap may vary.

In some embodiments, the strap may include multiple interlocking units. The multiple interlocking units may be connected to each other to form a chain like structure. The strap including the multiple interlocking units is configured to compress and expand.

The present disclosure provides a myofascial release device (MFRD) including a therapy device including a rod, and one or more treads configured to be attached to multiple places on a surface of the rod. The MFRD is a self-massage device configured to enable a user to alleviate muscle tightness and relieve tight fascia resulting in improved biomechanical function and an immediate feeling of relief.

According to an aspect of the present disclosure, the strap enables leverage by the therapy device without contorting against a wall and resulting in a lot of pressure exerted by the therapy device with little effort. The strap enables a user to use the therapy device conveniently and the muscular tension releasing system can be used on the couch. This is important because, while people have realized the importance of treating fascia, they often do not have the time to do so. However, individuals can use the disclosed muscular tension releasing system while watching television or listening to music.

The disclosed muscular tension releasing system is configured to be used on all body parts of the user. For example, but not limited to, neck, shoulders forearms, biceps, lower back, lateral deltoid (i.e. an outside shoulder muscle).

The disclosed muscular tension releasing system may include a therapy device comprising removable treads of varying shore hardness. This may allow the user to customize the muscular tension releasing system according to their preferences and needs. For example, if the user need to treat muscles in one area only then the user may attach two or three treads on the therapy device.

According to an aspect of the present disclosure, the plurality of treads of the therapy device may have varying shape and size such as, depending on a shape and size of the plurality of receiving units of the therapy device. In some embodiments, the treads may have hex design, alternatively the treads may have a spikey design. In alternative embodiments, the plurality of treads may have a twin design like a peanut shape for use on both sides of the spine at once. More designs, shape, and size of the treads are possible. Further, the shape, size, and/or shore hardness of the treads may be customized according to the user requirement.

According to an aspect of the present disclosure, the muscular tension releasing system has an extensible and modular design. The therapy device may be formed using one or more modules or pieces (See FIG. 5). Therefore, the therapy device may be assembled for using, and may be disassembled when not in use for storage or for carrying from one place to other. Hence, the muscular tension releasing system is compact and may be stored in less storage space. In some embodiments, the rod of the therapy device is formed using eleven pieces and five treads.

In some embodiments, the therapy device includes a single rod includes one or more ends, bearing surfaces, and slots for accepting one or more treads. The treads may or may not be removable from the therapy device.

The disclosed muscular tension releasing system can be designed in different lengths. Further, a shape and size of the treads may vary depending on a requirement of the user.

According to an aspect of the present disclosure, the treads comprises knobby bits that are positioned in a manner to press a particular type of muscle. The hook of the strap is put on the bearing surface of the therapy device near one of the ends (an end near the big tread)—then one of the treads (for example, a tread with a red hex) may sit right in the meat of the top of a trapezius muscle of the user.

An embodiment of the present disclosure provides a myofascial release system configured to use for releasing tension in muscles and relieve fascia that is knotted up. The system includes a therapy device and a strap. The strap may be formed using a flexible and durable material such as, but not limited to, a nylon webbing. Further, the strap may include one or more attachment units, such as one or more hooks, for attaching or clipping onto one or more bearing surfaces on each end. Further, the strap includes one or more holder for enabling a user to hold the strap for positioning the therapy device in accordance with a body part where the user wants to put pressure on. The holder may include at least one of a hand holds and a foot holds which may be sewn at an interval of 200 millimeter on the strap. In some embodiments, the strap may be 1900 millimeter long. Further, the therapy device may be made of a 14-millimeter steel rod coated in polyurethane elastomer and may have at least five removable treads made of silicon or rubber. The removable treads may have a varying shore hardness. The strap may be used as an anchor so that the user can put pressure on a knotted fascia.

In some embodiments, a length of the therapy device without the treads may be 545 millimeter. Each of the treads when installed on the rod of the therapy device may increase the length of the therapy device approximately by 7 millimeter to 10 millimeter on each end of the therapy device.

The muscular tension releasing system may be formed in any suitable color such as, but not limited to, red, blue, black, white, blue, and so forth. In some embodiments, more than one color may be used for making the muscular tension releasing device.

In some embodiments, the muscular tension releasing system further includes a stand having one or more rollers configured to be slotted into the one or more bearing surfaces of the therapy device. The stand may be a removed from the therapy device when not required.

In compliance with the statute, the invention has been described in language more or less specific to structural or methodical features. The term “comprises” and its variations, such as “comprising” and “comprised of’ is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

1. A muscular tension releasing system comprising:
a therapy device comprising a first end, a second end, and an elongate rod extending from the first end to the second end, wherein the elongate rod comprises:
a plurality of treads comprising a plurality of knobby bits;
a plurality of receiving units configured to receive at least one tread of the plurality of treads;
one or more bearing surfaces present on at least one of the first end and the second end; and
a coating of a durable coating material;
and a strap, which in use connects to at least one of the first end and the second end of the therapy device and extends in a lateral direction away from the therapy device, the strap comprising:
a plurality of interlocking units configured to be connected to each other to form a length of the strap, wherein interconnecting units can be removed, by disconnecting from connected units, or added to adjust the length of the strap; the strap is configured to compress and expand;
one or more attachment units for attaching to at least one of the first end and the second end of the therapy device; and
at least one holder for enabling a user to hold the strap for positioning the therapy device according to a body part where the user wants to put pressure on, wherein the strap enables the user to control an amount of pressure exerted by the therapy device on one or more muscles of the body part.

2. The muscular tension releasing system of claim 1, wherein the rod is formed using a rod material comprising one or more of: steel, iron, aluminum, wood, and carbon fiber.

3. The muscular tension releasing system of claim 1, wherein a tread material of the plurality of treads comprises at least one of: a silicon, rubber, plastic, wood, and polyurethane elastomer.

4. The muscular tension releasing system of claim 3, wherein the plurality of treads are configured to be removed from the plurality of receiving units.

5. The muscular tension releasing system of claim 1, wherein the plurality of treads remain in a fixed position.

6. The muscular tension releasing system of claim 1, wherein the plurality of treads are configured to rotate for massaging the body part.

7. The muscular tension releasing system of claim 1, wherein the strap is formed using a flexible and durable material comprising nylon, cloth, rubber, fabric, and plastic, further wherein at least one end of the strap comprises an anchor for fixing to one of the first end and the second end of the therapy device.

8. The muscular tension releasing system of claim 1, wherein the one or more holder includes at least one of a hand hold and a foot hold.

9. The muscular tension releasing system of claim 1, wherein the one or more holder are sewn at an interval of 200 millimeter on the strap.
